(19) United States
(12) Patent Application Publication
(10) Pub. No.: US 2024/0336156 A1
(43) Pub. Date: Oct. 10, 2024

(54) AUTOMATED FLEET-CONNECTED CHARGING SYSTEM

(71) Applicant: GM Cruise Holdings LLC, San Francisco, CA (US)

(72) Inventors: Kenneth Ferguson, Scottsdale, AZ (US); Jeffrey Brandon, Phoenix, AZ (US)

(73) Assignee: GM Cruise Holdings LLC, San Francisco, CA (US)

(21) Appl. No.: 18/296,844

(22) Filed: Apr. 6, 2023

(51) Int. Cl. B60L 53/35; B60L 53/16; B60L 53/30

(52) U.S. Cl. CPC B60L 53/35; B60L 53/16; B60L 53/305

(57) ABSTRACT

Systems and methods for automated charging of electric vehicles. The systems and methods for automated charging eliminate the need for human interaction with the vehicle and/or charging system. Additionally, systems and methods are provided for a high-utilization system in which one robotic system can be used to connect and disconnect multiple chargers to vehicles in a facility. In particular, a system is provided for connecting and disconnecting electric vehicles with chargers, without each charger having its own robotic arm. In some examples, an overhead gantry system includes a robotic arm that can move from charger to charger to connect (and/or disconnect) vehicles. In other examples, a ground-based robot moves from charger to charger to connect (and/or disconnect) vehicles.

### CROSS-REFERENCE TO RELATED APPLICATIONS

This application is related to U.S. Non-Provisional Patent Application entitled “Automated Fleet-Connected Cleaning and Inspection System”, filed concurrently herewith, the contents of which are incorporated herein by reference in their entirety and for all purposes.

### BACKGROUND

### 1. Technical Field

The present disclosure generally relates to vehicle charging and, more specifically, to electric vehicle charging systems.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIGS. 1A, 1B illustrate autonomous vehicles for automated charging, according to some examples of the present disclosure;

FIGS. 2A and 2B illustrate a charging facility system for automated vehicle charging, according to some examples of the present disclosure;

FIGS. 3A-3B illustrate examples of a robotic arm, according to some examples of the present disclosure;

FIG. 4 shows an example of a robotic hand that can be attached to a robotic arm, according to various examples of the present disclosure;

FIG. 5 shows an example of an autonomous ground-based robot, according to various examples of the present disclosure;

FIGS. 6A-6B illustrate examples of elevator-style trip logic for determining robotic arm movement, according to various examples of the present disclosure;

FIG. 7 is a flowchart illustrating a method for automated fleet-connected charging, according to some examples of the present disclosure;

FIG. 8 is a flowchart illustrating a method for automated fleet-connected charging, according to some examples of the present disclosure;

FIG. 9 is a diagram illustrating a fleet of autonomous vehicles in communication with a central computer, according to some embodiments of the disclosure;

FIG. 10 illustrates an example system environment that can be used to facilitate autonomous vehicle (AV) dispatch and operations, according to some aspects of the disclosed technology; and

FIG. 11 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview

Systems and methods are provided for automated charging of electric vehicles. The systems and methods for automated charging eliminate the need for human interaction with the vehicle and/or charging system. Additionally, systems and methods are provided for a high-utilization system in which multiple chargers can be connected and/or disconnected to vehicles in a facility, without a robotic system at each charger. In particular, a system is provided for connecting and disconnecting electric vehicles with chargers, without each charger having its own robotic arm. In some examples, an overhead gantry system includes a robotic arm that can move from charger to charger to connect (and/or disconnect) vehicles. In other examples, a ground-based robot moves from charger to charger to connect (and/or disconnect) vehicles.

In some implementations, the charging system is connected to a vehicle fleet via a dispatch system, and the dispatch system can provide detailed information to the charging system regarding a vehicle that is scheduled to arrive at the charging facility for charging. In some examples, the dispatch system can determine where to position an incoming vehicle in a charging facility based on the vehicle state and/or the charging system state. In some examples, the charging system can determine where to position an incoming vehicle in a charging facility based on the vehicle state and/or the charging system state. In some implementations, the charging system is a standalone system that monitors the charging system environment to determine where to position an incoming vehicle for charging. In further examples, a vehicle can pull into any empty charging space, and the charging system identifies the new vehicle via sensors at the charging space.

### Example Vehicle for Automated Charging

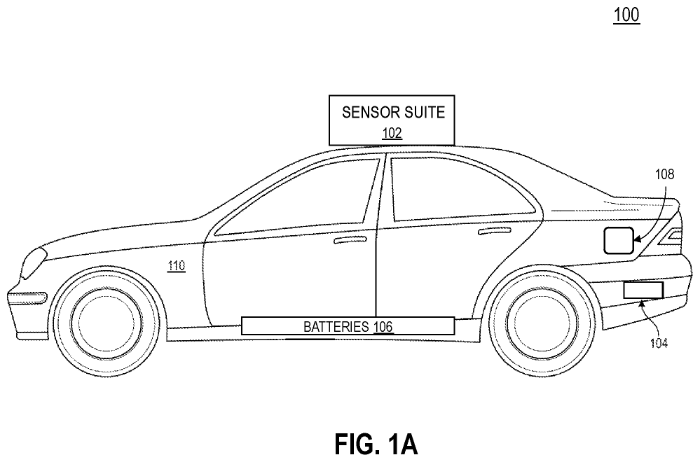

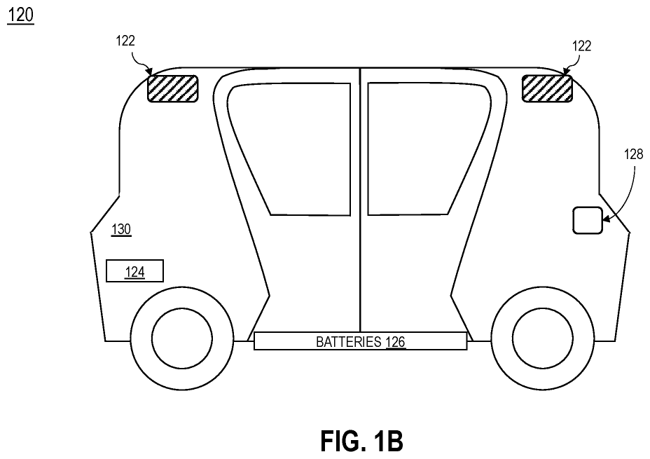

FIGS. 1A-1B illustrate autonomous vehicles 110, 130 for automated charging, according to some examples of the present disclosure. The autonomous vehicle 110 includes a sensor suite 102 and an onboard computer 104, and the autonomous vehicle 130 includes sensor suites 122 and an onboard computer 124. In various implementations, the autonomous vehicles 110, 130 uses sensor information from the sensor suites 102, 122 to determine vehicle location, to navigate traffic, to sense and avoid obstacles, and to sense vehicle surroundings. According to various implementations, the autonomous vehicles 110, 130 are part of a fleet of vehicles for picking up passengers and/or packages and driving to selected destinations. In some examples, the autonomous vehicles 110, 130 are personal autonomous vehicles that are used by one or more owners for driving to selected destinations. In some examples, the autonomous vehicles 110, 130 can connect with a central computer to download vehicle updates, maps, and other vehicle data. The autonomous vehicles 110, 130 each include a charging port 108, 128, respectively. The location of the charging port 108, 128 can vary depending on the model of the vehicle 110, 130. A charger can be connected to the charging ports 108, 128 to charge the batteries 106, 126 of the vehicles 110, 130.

The sensor suites 102, 122 include localization and driving sensors. For example, the sensor suite 102 may include one or more of photodetectors, cameras, RADAR, sound navigation and ranging (SONAR), LIDAR, Global Positioning System (GPS), inertial measurement units (IMUs), accelerometers, microphones, strain gauges, pressure monitors, barometers, thermometers, altimeters, wheel speed sensors, and a computer vision system. The sensor suites 102, 122 continuously monitor the autonomous vehicle's environment. In particular, the sensor suites 102, 122 can be used to identify information and determine various factors regarding an autonomous vehicle's environment. In some examples, data from the sensor suite 102, 122 can be used to update a map with information used to develop layers with waypoints identifying various detected items, such as locations of roadside shelters. Additionally, sensor suite 102, 122 data can provide localized traffic information, ongoing road work information, and current road condition information. Furthermore, sensor suite 102, 122 data can provide current environmental information, including current roadside environment information, such as the presence of people, crowds, and/or objects on a roadside or sidewalk. In this way, sensor suite 102, 122 data from many autonomous vehicles can continually provide feedback to the mapping system and a high fidelity map can be updated as more and more information is gathered.

In various examples, the sensor suite 102, 122 includes cameras implemented using high-resolution imagers with fixed mounting and field of view. In further examples, the sensor suite 102, 122 includes LIDARs implemented using scanning LIDARs. Scanning LIDARs have a dynamically configurable field of view that provides a point cloud of the region intended to scan. In still further examples, the sensor suite 102, 122 includes RADARs implemented using scanning RADARs with dynamically configurable field of view.

The autonomous vehicles 110, 130 each include an onboard computer 104, 124 which functions to control the autonomous vehicle 110, 130. The onboard computer 104, 124 processes sensed data from the sensor suite 102, 122 and/or other sensors, in order to determine a state of the autonomous vehicle 110, 130. Additionally, the onboard computer 104, 124 processes data for charging, and can use sensor suite 102, 122 data for identifying a charging space in a charging facility. In some examples, the onboard computer 104, 124 checks for vehicle updates from a central computer or other secure access point. In some examples, a vehicle sensor log receives and stores processed sensed sensor suite 102, 122 data from the onboard computer 104, 124. In some examples, a vehicle sensor log receives sensor suite 102, 122 data from the sensor suite 102, 122. The vehicle sensor log can be used to determine a state of a vehicle and various maintenance items such as charging and cleaning. In some implementations described herein, the autonomous vehicles 110, 130 include sensors inside the vehicle. In some examples, the autonomous vehicles 110, 130 include one or more cameras inside the vehicle. The cameras can be used to detect items or people inside the vehicle. In some examples, the autonomous vehicles 110, 130 include one or more weight sensors inside the vehicle, which can be used to detect items or people inside the vehicle. In some examples, the interior sensors can be used to detect passengers inside the vehicle. Additionally, based upon the vehicle state and programmed instructions, the onboard computer 104, 124 controls and/or modifies driving behavior of the autonomous vehicle 110, 130.

The onboard computer 104, 124 functions to control the operations and functionality of the autonomous vehicle 110, 130 and processes sensed data from the sensor suite 102, 122 and/or other sensors in order to determine states of the autonomous vehicle. In some implementations, the onboard computer 104, 124 is a general purpose computer adapted for I/O communication with vehicle control systems and sensor systems. In some implementations, the onboard computer 104, 124 is any suitable computing device. In some implementations, the onboard computer 104, 124 is connected to the Internet via a wireless connection (e.g., via a cellular data connection). In some examples, the onboard computer 104, 124 is coupled to any number of wireless or wired communication systems. In some examples, the onboard computer 104, 124 is coupled to one or more communication systems via a mesh network of devices, such as a mesh network formed by autonomous vehicles.

According to various implementations, the autonomous driving systems 100, 120 of FIGS. 1A, 1B function to enable an autonomous vehicle 110, 130 to modify and/or set a driving behavior in response to parameters set by vehicle passengers (e.g., via a passenger interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110. 130 is preferably a fully autonomous automobile, but may additionally or alternatively be any semi-autonomous or fully autonomous vehicle. In various examples, the autonomous vehicle 110, 130 is a boat, an unmanned aerial vehicle, a driverless car, a golf cart, a truck, a van, a recreational vehicle, a train, a tram, a three-wheeled vehicle, a bicycle, a scooter, a tractor, a lawn mower, a commercial vehicle, an airport vehicle, or a utility vehicle. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110, 130 includes a throttle interface that controls an engine throttle, motor speed (e.g., rotational speed of electric motor), or any other movement-enabling mechanism. In various implementations, the autonomous vehicle 110, 130 includes a brake interface that controls brakes of the autonomous vehicle 110, 130 and controls any other movement-retarding mechanism of the autonomous vehicle 110, 130. In various implementations, the autonomous vehicle 110, 130 includes a steering interface that controls steering of the autonomous vehicle 110, 130. In one example, the steering interface changes the angle of wheels of the autonomous vehicle. The autonomous vehicle 110, 130 may additionally or alternatively include interfaces for control of any other vehicle functions, for example, windshield wipers, headlights, turn indicators, air conditioning, etc.

### System for Automated Fleet-Connected Charging

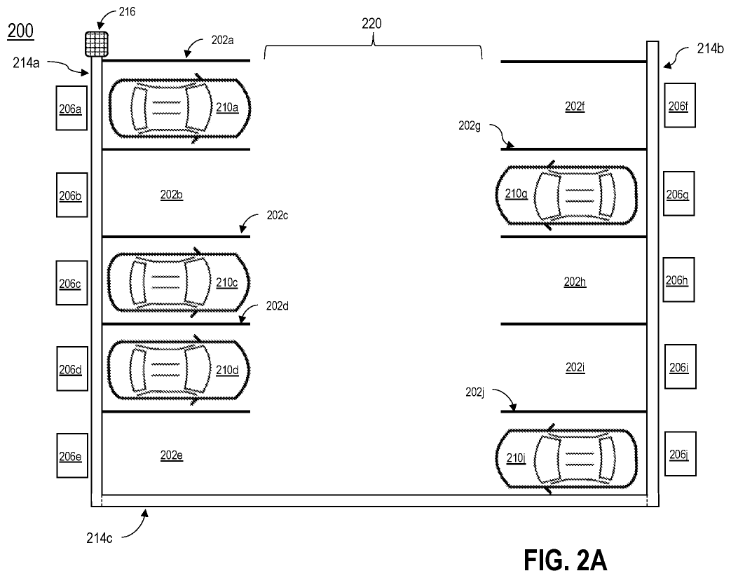

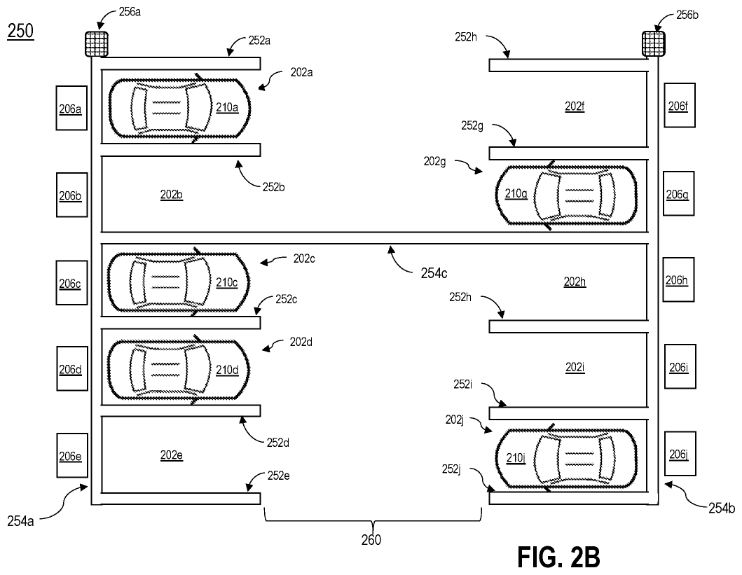

FIGS. 2A and 2B illustrate charging facility systems 200, 250 for automated vehicle charging, according to some examples of the present disclosure. The charging facility systems 200, 250 include ten vehicle charging spots 202a-202j, each charging spot 202a-202j having a corresponding charging station 206a-206j. In some examples, each charging station includes a charging station plug which is connected to the charging station with a cord. When the charging station plug is connected to a vehicle charging port, the charging station charges the vehicle battery.

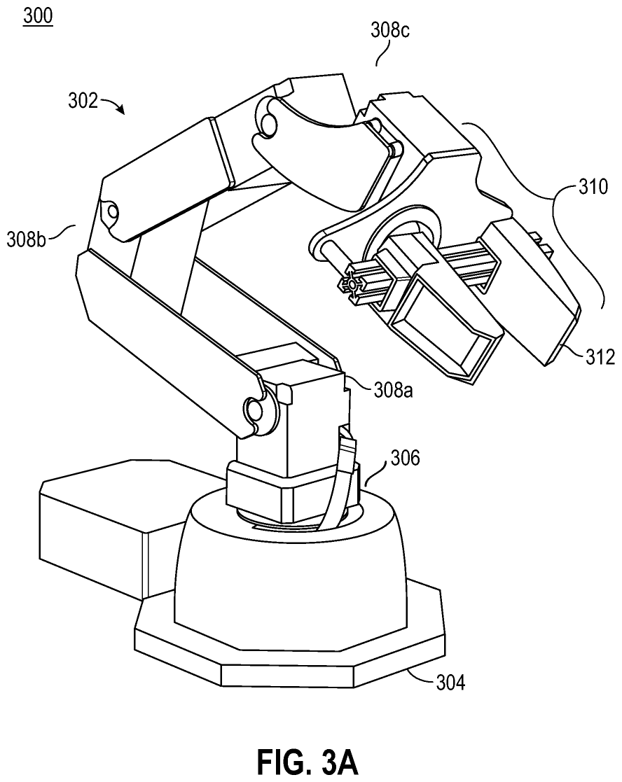

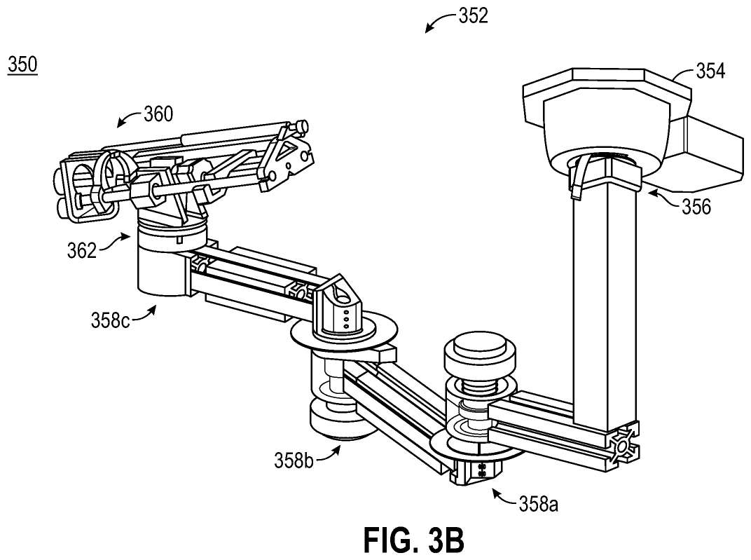

As shown in FIG. 2A, the charging facility system 200 includes a track 214a, 214c, 214b past the charging stations 206a-206j. A robotic arm 216 can travel along tracks 214a, 214b, 214c to any of the charging stations. In various examples, the robotic arm 216 is configured to connect charging station plugs to vehicle charging ports. The robotic arm 216 can travel along the track 214a, 214b, 214c and stop at a charging station 206a-206j. When a vehicle parks in a vehicle charging spot 202a-202j for charging, the robotic arm 216 travels to the vehicle, identifies the vehicle charging port, opens the vehicle charging port, and connects the charging station plug to the vehicle charging port. In some examples, the robotic arm grasps (or otherwise secures, and/or rigidly secures) the charging station plug to connect the plug with the vehicle charging port. In some examples, the robotic arm 216 can perform other tasks such as vehicle cleaning and vehicle inspections. Examples of robotic arms are discussed below with respect to FIGS. 3-5.

In various implementations, the robotic arm 216 includes a sensor system to determine where a charging station plug is and where a vehicle charging port door is. The sensor system can be used to execute the steps to grab the charging station plug, insert the charging station plug into the vehicle charging port, and remove the charging station plug from the vehicle charging port. In various examples, the sensor system includes one or more of LIDAR sensors, RADAR sensors, and image sensors (e.g., a camera).

In various examples, the track 214a, 214b, 214c is an overhead gantry rail system and the robotic arm 216 is mounted on the overhead gantry rail. The overhead gantry rail system can include a rail track that is positioned above the height of the vehicles that use the charging facility, such that the robotic arm 216 can travel along the track 214a, 214b, 214c above the vehicles, and vehicles can drive underneath the track 214a, 214b, 214c. The robotic arm 216 extends downward from the overhead gantry rail track 214a, 214b, 214c, similar to an inverted (upside down) AGV (Automatic Guided Vehicle) with wheels rotated 90 degrees to mount on the rail track 214a, 214b, 214c.

In some examples, the overhead gantry rail track 214a, 214b, 214c is positioned above the charging stations 206a-206j. Vehicles can drive through a driving lane 220 to the charging spaces 202a-202j from either direction. In some examples, the overhead gantry rail track 214a, 214b, 214c include one straight track such as 214a, while in other examples, the overhead gantry rail track includes corners with a first portion of the track at an angle compared to a second portion (e.g., between track portions 214a and 214c and between track portions 214c and 214b). As shown in FIG. 2A, the charging facility system 200 includes a first set of five adjacent charging spaces 202a-202e, each having a corresponding charging station 206a-206e, and a second set of five adjacent charging spaces 202f-202j, each having a corresponding charging station 206f-206j. In some examples, the overhead gantry rail system includes a track which includes a middle track portion 214c connecting a first track portion 214a over the first set of charging stations 206a-206e with second track portion 214b over the second set of charging stations 206f-206j. Thus, the overhead gantry rail system allows the robotic arm 216 to travel along the track 214a, 214b, 214c to any of the charging stations 206a-206j. In other examples, the overhead gantry rail system can include two unconnected tracks: one track 214a over the first set of charging stations 206a-206e and one track 214b over the second set of charging stations 206f-206j, with each track 214a, 214b having a robotic arm 216. In some examples, the rail system described herein can be positioned on the ground, at waist level, or at any other selected height. The robotic arm can be positioned on the track accordingly. For instance, for a rail system positioned on the ground, the robotic arm extends upwards.

FIG. 2B shows a charging facility system 250, including tracks 254a, 254b, 254c, and 252a-252j. The charging facility system 250 shows two robotic arms 256a, 256b. In various examples, the charging facility system 250 can include just one robotic arm 256a, 256b. As shown in FIG. 2B, horizontal tracks 252a-252j and track 254c allow a robotic arm 256a, 256b to traverse next to a vehicle. The track 254c allows a robotic arm 256a, 256b to cross a driving lane 260 from one set of charging stations (e.g., the first set 206a-206e) to the other set of charging stations (e.g., the second set 206f-206j). The track 254c does not block the driving lane 260. For instance, the track 254c can be an overhead track that vehicles can drive underneath. In some examples, a robotic arm 256a, 256b may stop next to a vehicle to perform various activities. In one example, if a vehicle parks with the vehicle front facing the charging station, a robotic arm 256a, 256b can travel along one of the horizontal tracks 252a-252j, 254c to connect a charging plug to a charging port at the rear of the vehicle. In some implementations, a robotic arm 256a, 256b can perform other functions such as vehicle cleaning and vehicle inspections.

### Robot for Automated Fleet-Connected Charging

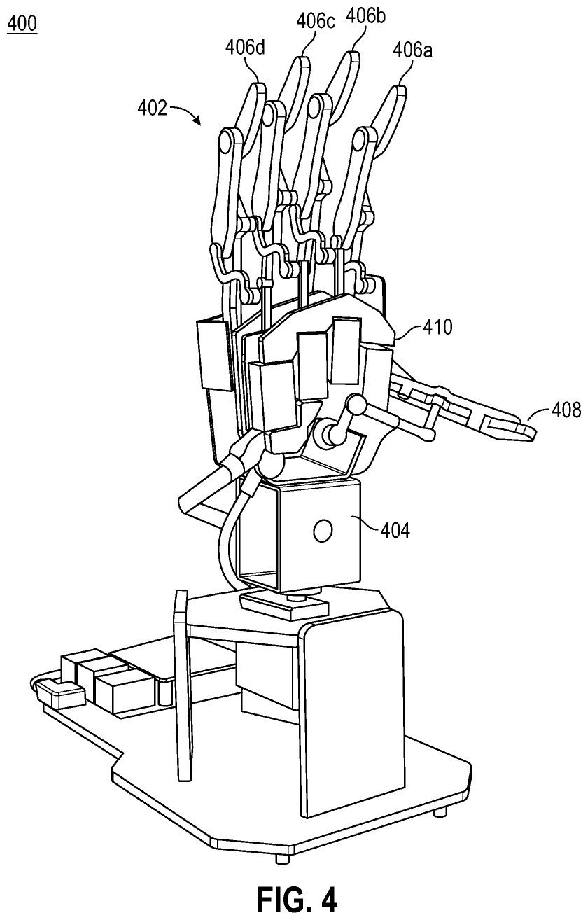

FIG. 3A illustrates an example 300 of a robotic arm 302, according to various examples of the present disclosure. In various examples, the robotic arm 302 can be configured to travel along a track in a charging facility as described above with respect to FIGS. 2A-2B. In some examples, the base 304 of robotic arm 302 shown in FIG. 3A is attached to a wheeled base to travel along a track. In some examples, the robotic arm 302 is attached to an overhead base portion such that the arm hangs down from the base and can travel along an overhead gantry track. The robotic arm 302 includes a rotating bottom joint 306, which can rotate 360 degrees, allowing it to rotate to any position around the base 304, and three elbow joints 308a, 308b, 308c. The elbow joints 308a, 308b, 308c allow the head portion 310 of the robotic arm to be at any selected position with respect to the base 304. The head portion 310 of the robotic arm 302 includes a two-prong pincher 312 that can grasp items. In various examples, the two-prong pincher 312 can grasp a charging system plug, and the robotic arm can connect the plug with a vehicle charging port. In some examples, the two-prong pincher 312 can be used to push a button. In various examples, the head portion 310 can include a different mechanism for grasping and/or holding items. For instance, the head portion 310 can include an electromagnetic head designed to hold a charging plug via a magnetic force, where the magnetic force can be turned on to connect to the plug, and the magnetic force can be turned off to disconnect from the plug. In another example, the head portion 310 can include a robotic hand, as shown in FIG. 4.

FIG. 3B illustrates an example 350 of a robotic arm 352, according to various examples of the present disclosure. In various examples, the robotic arm 352 can be configured to travel along a track in a charging facility as described above with respect to FIGS. 2A-2B. In some examples, the robotic arm 352 is attached to a base 354, similar to the base 304 shown in FIG. 3A, and the robotic arm 352 can be attached to a wheeled base to travel along a track. As shown in FIG. 3B, the robotic arm 352 is hanging down from the base 354 such that the track can be an overhead gantry track. In other examples, the robotic arm 352 can be configured to attach to a base that travels along a floor track. The robotic arm 352 includes a rotating bottom joint 356, which can rotate 360 degrees, allowing it to rotate to any position around the base 354. The robotic arm 352 includes a swivel joint 362 and three rotating joints 358a, 358b, 358c. The head portion 360 of the robotic arm 352 can include a charging plug insertion mechanism. In various examples, the charging plug insertion mechanism can be used to insert a charging system plug, and the robotic arm 352 can connect the plug with a vehicle charging port. In some examples, the head portion 360 can be used to push a button. In various examples, the head portion 360 can include a different mechanism for grasping and/or holding items. For instance, the head portion 360 can include an electromagnetic head designed to hold a charging plug via a magnetic force, where the magnetic force can be turned on to connect to the plug, and the magnetic force can be turned off to disconnect from the plug. In another example, the head portion 360 can include a two-prong pincher 312 as shown in FIG. 3A or a robotic hand, as shown in FIG. 4.

In particular, FIG. 4 shows an example 400 of a robotic hand 402 that can be attached to a robotic arm, according to various examples of the present disclosure. In one example, the robotic arm 302 includes a robotic hand 402 in place of the head portion 310 illustrated in FIG. 3A or FIG. 3B. The robotic hand 402 can clasp items similar to the way a human hand clasps items. The robotic hand 402 includes a wrist portion 404 that can rotate 360 degrees, four finger extensions 406a-406d and one thumb extension 408. Like human fingers, the four finger extensions 406a-406d each have a base joint and two upper joints, allowing them to fold inward toward a center palm area 410 and extend outward. Similarly, the thumb extension 408 has a base joint and two upper joints. In some examples, the robotic hand 402 finger extensions 406a-406d and thumb extension 408 can also be used to press buttons and perform other functions performed by human hands. In some examples, one or more of the finger extensions 406a-406d and thumb extension 408 can include a selectively activated magnet and/or electromagnet to selectively magnetically attach to various items and pick up, move, and/or disengage from the items.

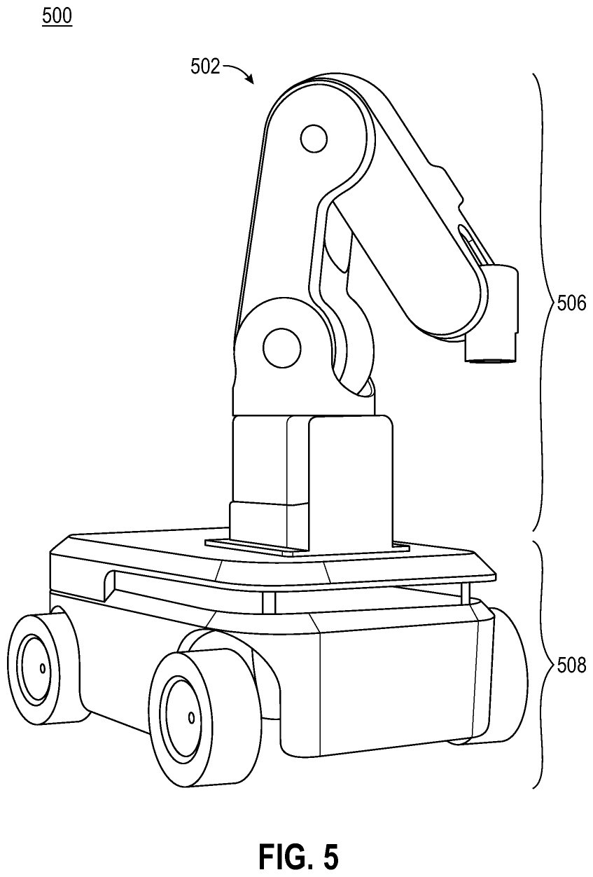

In some implementations, a charging facility system includes a ground-based robot that can move from charger to charger without following along a track. For instance, the ground-based robot can be an AGV, and it can be an R2D2-style robot. FIG. 5 shows an example 500 of an autonomous ground-based robot 502, according to various examples of the present disclosure. The ground-based robot 502 includes a wheeled base that allows the ground-based robot 502 to travel around a charging facility. In various examples, the ground-based robot 502 is not restricted to travel along a pre-existing rail and can maneuver around the charging facility. The ground-based robot 502 includes a wheeled base portion 504 and a robotic arm portion 506. The ground-based robot can be configured with any selected robotic arm attached to the wheeled base portion 504. For example, the robotic arm 302 shown in FIG. 3A and/or the robotic arm 352 shown in FIG. 3B can be attached to the wheeled base portion 504. Similarly, the robotic hand 402 can be attached to the robotic arm portion 506, and the robotic hand 402 can be attached to any selected robotic arm on the wheeled base portion 504. The ground-based robot 502 can include integrated sensors for navigating around a charging facility. In some examples, the ground-based robot 502 includes one or more of LIDAR sensors, RADAR sensors, and image sensors.

### Methods for Automated Fleet-Connected Charging

There are various methods for determining where a robotic arm will travel within a charging facility. In one example, a robotic arm can follow elevator-style trip logic. Following elevator-style trip logic, based on a signal of a first location where the robotic arm is needed, the robotic arm follows a predetermined path to relocate to the first location. If, en route to the first location, a signal is received that a second location requests the robotic arm and the second location is along the route the robotic arm is taking, ahead of its current position, the robotic arm stops at the second location to perform the appropriate action at the second location before continuing to the first location.

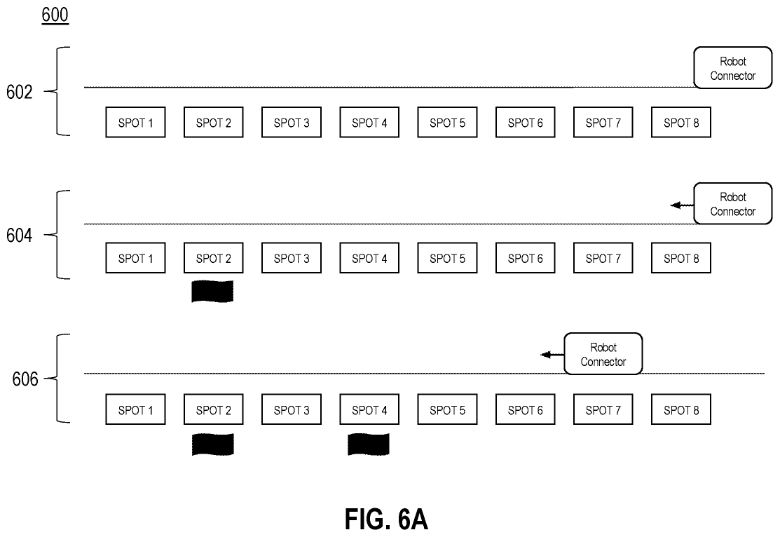

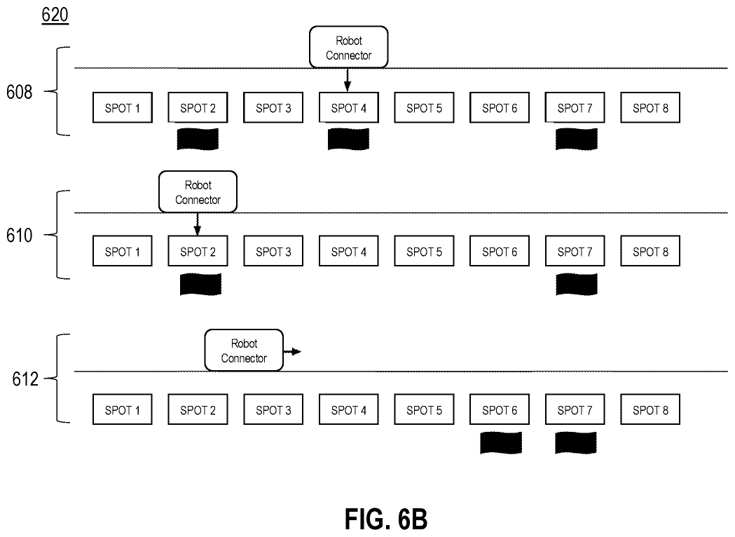

FIGS. 6A-6B illustrate examples 600-620 of elevator-style trip logic for determining robotic arm movement, according to various examples of the present disclosure. In particular, as shown at section 602, a charging facility includes eight spots, none of which are flagged for the robotic arm. At section 604, spot 2 raises a flag, requesting the robotic arm. The robotic arm begins traveling toward spot 2. At section 606, spot 4 raises a flag, requesting the robotic arm. Since spot 4 is between the robotic arm and spot 2, the robotic arm stops at spot 4 before continuing on to spot 2. At section 608, while the robotic arm is stopped at spot 4, spot 7 raises a flag, requesting the robotic arm. However, since the robotic arm is already on its way to spot 2, and spot 7 is in the opposite direction from the robotic arm's path to spot 2, the robotic arm continues to proceed to spot 2 when it is finished at spot 4. When the robotic arm is finished at spot 4, the flag for spot 4 is turned off. Section 610 illustrates the robotic arm stopped at spot 2, following its stop at spot 4, with the flag for spot 7 still raised. Last, at section 612, the robotic arm is finished at spot 2, and begins to travel to spot 7. However, before the robotic arm reaches spot 7, spot 6 raises its flag. Thus, the robotic arm will stop at spot 6 to perform the appropriate action before proceeding to spot 7.

In some implementation, the robotic arm system can communicate with the vehicle and/or with the cleaning facility system. If the robotic arm system encounters an issue at a particular spot in the cleaning facility, the robotic arm system can communicate with the vehicle to request the vehicle travel to a different spot for cleaning. In some examples, operations can fix the issue with the particular spot while the robotic arm system continues to clean vehicles in other spots.

Another method for determining where a robotic arm will travel within a charging facility is simply a first come-first serve model, in which the robotic arm travels to each spot in the order in which requests are received. In another method, various vehicle parameters are considered in prioritizing order, where the vehicle parameters can include the state of charge of a vehicle, any upcoming scheduled trips for the vehicle, a priority request, an urgency flag, or other parameters.

A further method for determining where a robotic arm will travel within a charging facility includes a dispatch-connected management system that preemptively positions the robotic arm based on where (which vehicle charging spot) a vehicle will arrive and the specific time the vehicle will arrive and/or from where and at what time a vehicle will depart. In particular, the robotic arm moves to the appropriate location based on queue expectations. Thus, for example, the queue requests for the robotic arm can include (1) a first vehicle arrives at spot 2 in 20 seconds, (2) a second vehicle arrives at spot 4 in 53 seconds, (3) a third vehicle request for disconnect from the charging station at spot 8 in 1 minute and 42 seconds, for schedule departure. The robotic arm can preemptively position itself at spot 2, ready to connect the first vehicle when it arrives, and following completion of the connection, the robotic arm moves to spot 4, ready to connect the second vehicle when it arrives. Similarly, following completion of the connection of the second vehicle, the robotic arm moves to spot 8 to disconnect the third vehicle at the requested time.

According to various examples, a flag indicating the request for the robotic arm at a specific spot can be generated multiple different ways. A first technique for generating the request is a standalone solution in which there is no communication between the vehicle and the robotic arm. In this technique, the robot can use perception to determine if a vehicle needs a connection with a charging station plug or a disconnection from a charging station plug. In one example, the robotic arm detects the arrival of a vehicle at the charging facility and moves to the vehicle's space to connect the charging station plug. In another example, one or more sensors at the charging facility detect the arrival of a vehicle, and vehicle arrival is communicated with the robotic arm. In another example, one or more sensors at the vehicle parking space and/or at the charging station detect the arrival of a vehicle, and vehicle arrival is communicated with the robotic arm. When vehicle arrival is communicated with the robotic arm, the corresponding vehicle space is also communicated with the robotic arm, which flags the space on a list of spaces to service. In some examples, when a vehicle is finished charging, the charging station senses that no further charge is being transferred to the vehicle and communicates a charging station plug disconnection request to the robotic arm, which flags the space on a list of spaces to service.

A second technique for generating the request for the robotic arm is vehicle-to-robot communication. In particular, the vehicle can communicate with the robotic arm. For instance, the vehicle can send a signal to the robotic arm requesting a charger connection or disconnection. In some examples, the signal can include information indicating the vehicle location in the charging facility. Additionally, in some examples, the signal can include a specific time for connection or disconnection. For example, if a vehicle battery will complete charging at a selected time, the vehicle can request disconnection from the charging station at the selected time. In one example, the vehicle emits a light signal to indicate charging status. For instance, the vehicle can include a charge port light that blinks while the vehicle is actively charging and fully (continuously) illuminates when charging is complete. In some examples, the robotic arm controller includes perception capability to receive and interpret vehicle signals. For instance, the robotic arm controller can interpret the charge port lighting to determine when the vehicle is charging and when charging is complete.

A third technique for generating the request for the robotic arm is vehicle-to-charger-to-robot communication. In particular, the robotic arm communicates with the charging infrastructure, such as with the charging stations. The vehicle also communicates with the charging infrastructure, such as with the charging station corresponding to the vehicle's parking space. In one example, a vehicle communicates with a charging station as it pulls into a charging spot. The charging station receives information from the vehicle and generates a signal for the robotic arm. The information can include a request for the robotic arm to connect the charging station plug to the vehicle charging port. In some examples, the information can include information about the vehicle such as the current vehicle state of charge, the target vehicle state of charge, the current vehicle charge rate, and the estimated time to complete charging. In some examples, the estimated time to complete charging can be updated as the vehicle charges. In some examples, the robotic arm can plan and/or schedule a return to the charging station at the time that charging will be complete to disconnect the charging station plug from the vehicle charging port. In some examples, the charging station determines the corresponding parking space is occupied when establishing a connection with the vehicle occupying the space.

A fourth technique for generating the request for the robotic arm is vehicle-to-dispatch-to-robot communication. In particular, the robotic arm communicates with the fleet dispatch system, which can signal the robotic arm to reposition itself based on fleet vehicle information. When the vehicle arrival time at the charging station is known, and a charging spot for the vehicle is identified, the robotic arm can be proactively scheduled to be at the charging location when the vehicle is ready to be connected to the charging station plug. For example, a vehicle can communicate with the fleet dispatch system that it will arrive at the charging station at a selected time, and the fleet dispatch system can communicate the vehicle arrival time with the robotic arm. A parking space in at the charging facility can be identified for the vehicle, and the robotic arm can position itself at the identified charging space at the time the vehicle is ready for the charging station plug connection after arriving at the charging facility.

A fifth technique for generating the request for the robotic arm is vehicle-to-dispatch-to-charger-to-robot communication. In this technique, the fleet dispatch system can signal to the charging station to raise a flag for the robotic arm to reposition itself at the charging station. In some examples, the flag can include a specific time at which the robotic arm is requested at the charging station. In some examples, the fleet dispatch system has information about the charging stations and the corresponding parking spots in the charging facility, including which parking spots (and charging stations) are available at a specific time for vehicle charging. Thus, the dispatch system can direct a vehicle to a specific parking spot with a corresponding specific charging station. The specific charging station can communicate the expected arrival time of the vehicle with the robotic arm (or raise a flag for the robotic arm, where the flag includes a specific time the robotic arm is requested).

In various implementations, there are a number of factors that can contribute to a flag being raised for attention from the robotic arm. One factor is the current vehicle state-of-charge. For instance, a vehicle with a very low state-of-charge can have high priority for attention because it is undesirable to allow the charge to dip below a selected value, and especially undesirable to allow the vehicle battery charge to run out (to reach zero charge). Another factor is the target vehicle state-of-charge. For instance, as vehicle charging nears completion, a time for attention from the robotic arm to disconnect the charging station plug can be determined. Another factor is the current vehicle charging rate, which similarly can be used to determine charge time. Similarly, the estimated time to complete charging is a factor. Additionally, another factor is the parking spot status for a charging station. In particular, whether the parking space is currently empty or occupied can be considered. In some examples, a vehicle is scheduled for arrival at a charging facility (and to a particular parking spot) at a selected time, and a visit from the robotic arm for attention to connecting the vehicle with the charging station is scheduled based on the selected time. However, in various examples, the vehicle may not arrive at the charging facility or the vehicle may not park in the particular parking spot. Thus, the parking spot status can be considered before the robotic arm travels to the spot. Note that the flag is a digital flag that acts as a signal to the robotic arm to travel to the corresponding charging station. The flag can be a binary flag indicating visit or don't visit. Alternatively, the flag can have a range of values, for example indicating a priority level for attention from the robotic arm.

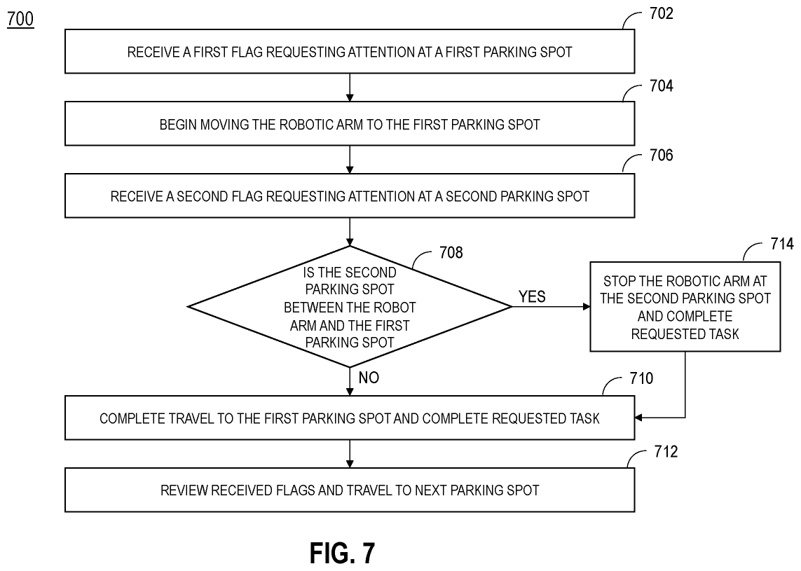

FIG. 7 is a flowchart illustrating a method 700 for automated fleet-connected charging, according to some examples of the present disclosure. In particular, the method 700 of FIG. 7 is a generalized method for a robot and/or robotic arm to follow the elevator-style trip logic in determining a charging spot to attend to. At step 702, a first flag is received, where the first flag indicates a request for attention at a first parking spot. In various examples, the first parking spot has a corresponding first charging station. At step 704, the robotic arm begins moving to the first parking spot. In some examples, at step 704, the robotic arm schedules the first parking spot as its next destination but does not yet begin moving before the method 700 proceeds to step 706. At step 706, a second flag is received, where the second flag indicates a request for attention at a second parking spot. At step 708, it is determined whether the second parking spot is between the robotic arm and the first parking spot. If the second parking spot is not between the robotic arm and the first parking spot, the method 700 proceeds to step 710, and the robotic arm continues its travel to the first parking spot. At the first parking spot, the robotic arm completes the requested task. For example, the robotic arm can connect the first charging station with a vehicle parked in the first parking spot. At step 712, the robot reviews its received flags and begins to travel to the next parking spot on its list. As described above, if the next received flag is in a selected direction, and the robots flag list includes one or more other flags in the selected direction between the robot and the next received flag, the robot stops at the first flagged spot in the selected direction. At step 708, if the second parking spot is between the robotic arm and the first parking spot, the method 700 proceeds to step 714, and the robotic arm stops at the second parking spot and completes the requested task before continuing on to the first parking spot (step 710).

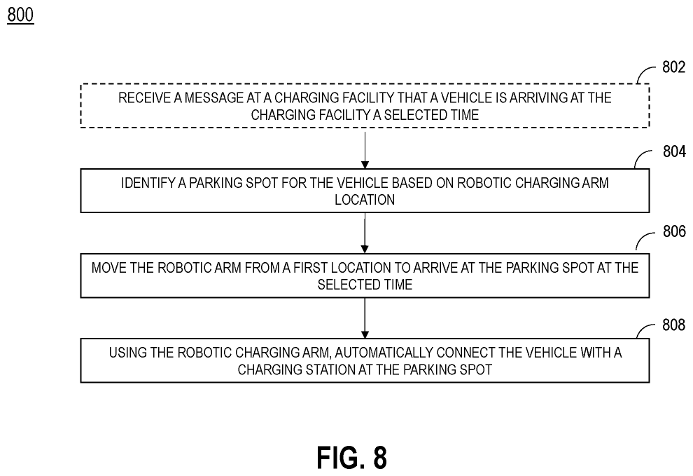

FIG. 8 is a flowchart illustrating a method 800 for automated fleet-connected charging, according to some examples of the present disclosure. In particular, the method 800 is a generalized method for planning for a robotic arm to be present at a parking spot when a vehicle arrives at the spot. The method 800 can be used by a dispatch-connected management system that preemptively positions the robotic arm based on which parking spot a vehicle will arrive at or depart from. At step 802, a message is received at a charging facility that the vehicle will arrive at the charging facility at a selected time. In some examples, the message is received from a dispatch service that is in communication with the vehicle. The dispatch service can receive the arrival time from the vehicle and/or the dispatch service can determine the arrival time based on the current vehicle location. The message can be received by the robot.

At step 804, a parking spot is identified for the vehicle. The parking spot can be identified based on the robotic arm location. In particular, a parking spot close to the robotic arm location can be selected. Alternatively, a parking spot can be identified that is close to the location the robotic arm is expected to be when the vehicle arrives at the charging facility. In another example, a parking spot can be selected based on the current list of locations the robotic arm is scheduled to visit, based on where (and when) the robotic arm can efficiently add a stop to the parking spot to its list. For instance, a first parking spot can be added to the end of the list, and the first parking spot selection can be based on the robotic arm location for the current last spot on the list. In some examples, the dispatch system can assign a parking spot to the vehicle before the vehicle arrives at the charging facility.

At step 806, the robotic arm moves from a first location to arrive at the identified parking spot at the selected time. In some examples, the robotic arm arrives at the identified parking spot before the vehicle arrives at the identified parking spot. In some examples, the robotic arm arrives at the identified parking spot at the same time as the vehicle arrives at the identified parking spot. At step 808, the robotic arm automatically connects the vehicle with a charging station at the parking spot. As described above, in various examples, the robotic arm opens the vehicle charging port, grabs the charging station plug, and connects the charging station plug with the vehicle charging port.

### Example of an Autonomous Vehicle Fleet

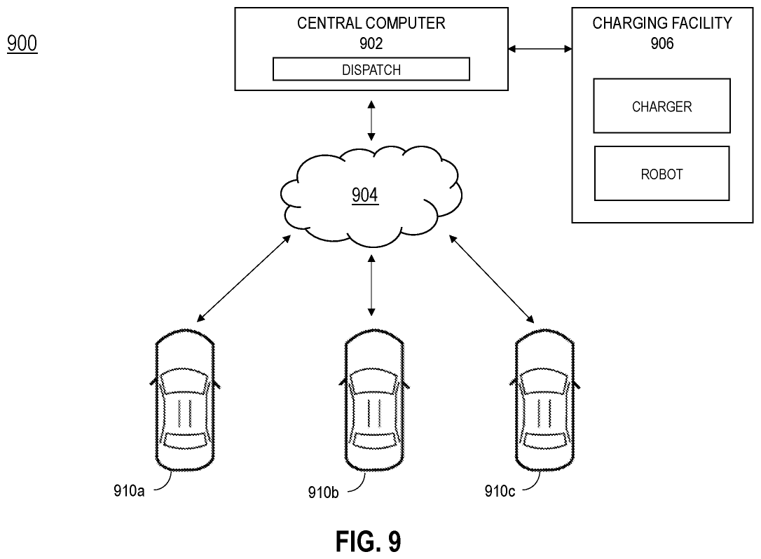

FIG. 9 is a diagram 900 illustrating a fleet of autonomous vehicles 910a, 910b, 910c in communication with a central computer 902, according to some embodiments of the disclosure. The vehicles 910a-910c communicate wirelessly with a cloud 904 and a central computer 902. The central computer 902 includes a routing coordinator, a dispatch service, and a database of information from the vehicles 910a-910c in the fleet. In some examples, the database of information can include a state of charge of each vehicle as well as other vehicle conditions and information. Autonomous vehicle fleet routing refers to the routing of multiple vehicles in a fleet. The central computer 902 also communicates with various fleet charging facilities such as the charging facility 906. In some examples, vehicles 910a-910c can communicate battery level with a dispatch system at the central computer. When a vehicle 910a-910c battery is low, the dispatch system can route the vehicle 910a-910c to a charging facility 906. Additionally, the dispatch system can provide the charging facility 906 with the time at which the vehicle 910a-910c will arrive at the charging facility 906, and the charging facility 906 can identify a parking spot for the vehicle 910a-910c. In some examples, the charging facility 906 can communicate the identified parking spot with the dispatch system and/or with the vehicle 910a-910c.

As described above, each vehicle 910a-910c in the fleet of vehicles communicates with a routing coordinator. Thus, information gathered by various autonomous vehicles 910a-910c in the fleet can be saved and used to generate information for future routing determinations. For example, sensor data can be used to generate route determination parameters. In general, the information collected from the vehicles in the fleet can be used for route generation or to modify existing routes. In some examples, the routing coordinator collects and processes position data from multiple autonomous vehicles in real-time to avoid traffic and generate a fastest-time route for each autonomous vehicle. In some implementations, the routing coordinator uses collected position data to generate a best route for an autonomous vehicle in view of one or more traveling preferences and/or routing goals. In some examples, the routing coordinator uses collected position data corresponding to emergency events to generate a best route for an autonomous vehicle to avoid a potential emergency situation and associated unknowns. In some examples, the routing coordinator generates a route for a vehicle to the charging facility 906. In some examples, a vehicle has one or more scheduled stops before embarking on its route to the charging facility 906.

### Example Autonomous Vehicle (AV) Management System

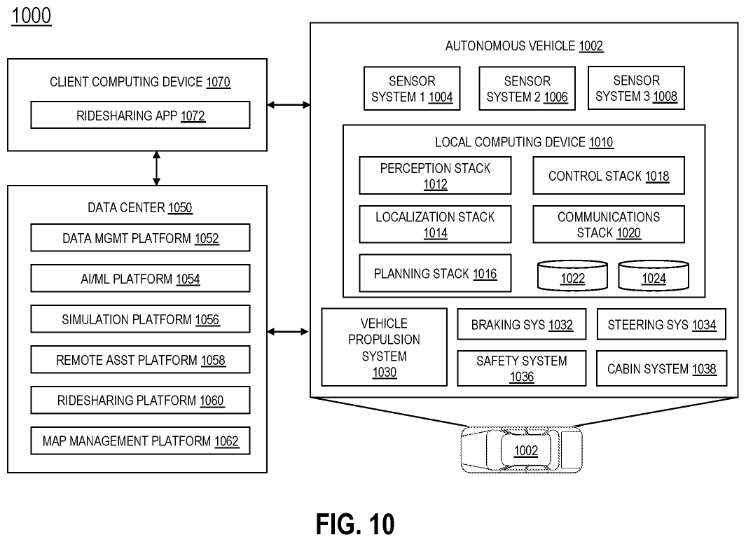

Turning now to FIG. 10, this figure illustrates an example of an AV management system 1000. One of ordinary skill in the art will understand that, for the AV management system 1000 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 1000 includes an AV 1002, a data center 1050, and a client computing device 1070. The AV 1002, the data center 1050, and the client computing device 1070 can communicate with one another over one or more networks (not shown), such as a public network (e.g., the Internet, an Infrastructure as a Service (IaaS) network, a Platform as a Service (PaaS) network, a Software as a Service (Saas) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 1002 can navigate about roadways without a human driver based on sensor signals generated by multiple sensor systems 1004, 1006, and 1008. The sensor systems 1004-1008 can include different types of sensors and can be arranged about the AV 1002. For instance, the sensor systems 1004-1008 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 1004 can be a camera system, the sensor system 1006 can be a LIDAR system, and the sensor system 1008 can be a RADAR system. Other embodiments may include any other number and type of sensors.

In some examples, the AV 1002 includes a charging port door sensor, which can be used to trigger the AV 1002 to unlock and/or open the charging port door. For instance, if the charging port door sensor senses a robotic arm and/or a charging station plug, the AV 1002 can use the sensed data to identify the presence of the robotic arm and/or charging station plug and unlock and/or autonomously open the charging port door. In some examples, the sensed data from the charging port door sensor is transmitted to the local computing device 1010, which uses the sensed data to identify the presence of the robotic arm and/or the charging station plug.

AV 1002 can also include several mechanical systems that can be used to maneuver or operate AV 1002. For instance, the mechanical systems can include vehicle propulsion system 1030, braking system 1032, steering system 1034, safety system 1036, and cabin system 1038, among other systems. Vehicle propulsion system 1030 can include an electric motor, an internal combustion engine, or both. The braking system 1032 can include an engine brake, a wheel braking system (e.g., a disc braking system that utilizes brake pads), hydraulics, actuators, and/or any other suitable componentry configured to assist in decelerating AV 1002. The steering system 1034 can include suitable componentry configured to control the direction of movement of the AV 1002 during navigation. Safety system 1036 can include lights and signal indicators, a parking brake, airbags, and so forth. The cabin system 1038 can include cabin temperature control systems, in-cabin entertainment systems, and so forth. In some embodiments, the AV 1002 may not include human driver actuators (e.g., steering wheel, handbrake, foot brake pedal, foot accelerator pedal, turn signal lever, window wipers, etc.) for controlling the AV 1002. Instead, the cabin system 1038 can include one or more client interfaces (e.g., Graphical User Interfaces (GUIs), Voice User Interfaces (VUIs), etc.) for controlling certain aspects of the mechanical systems 1030-1038.

AV 1002 can additionally include a local computing device 1010 that is in communication with the sensor systems 1004-1008, the mechanical systems 1030-1038, the data center 1050, and the client computing device 1070, among other systems. The local computing device 1010 can include one or more processors and memory, including instructions that can be executed by the one or more processors. The instructions can make up one or more software stacks or components responsible for controlling the AV 1002; communicating with the data center 1050, the client computing device 1070, and other systems; receiving inputs from riders, passengers, and other entities within the AV's environment; logging metrics collected by the sensor systems 1004-1008; and so forth. In this example, the local computing device 1010 includes a perception stack 1012, a mapping and localization stack 1014, a planning stack 1016, a control stack 1018, a communications stack 1020, a High Definition (HD) geospatial database 1022, and an AV operational database 1024, among other stacks and systems.

Perception stack 1012 can enable the AV 1002 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 1004-1008, the mapping and localization stack 1014, the HD geospatial database 1022, other components of the AV, and other data sources (e.g., the data center 1050, the client computing device 1070, third-party data sources, etc.). The perception stack 1012 can detect and classify objects and determine their current and predicted locations, speeds, directions, and the like. In addition, the perception stack 1012 can determine the free space around the AV 1002 (e.g., to maintain a safe distance from other objects, change lanes, park the AV, etc.). The perception stack 1012 can also identify environmental uncertainties, such as where to look for moving objects, flag areas that may be obscured or blocked from view, and so forth.

Mapping and localization stack 1014 can determine the AV's position and orientation (pose) using different methods from multiple systems (e.g., GPS, IMUs, cameras, LIDAR, RADAR, ultrasonic sensors, the HD geospatial database 1022, etc.). For example, in some embodiments, the AV 1002 can compare sensor data captured in real-time by the sensor systems 1004-1008 to data in the HD geospatial database 1022 to determine its precise (e.g., accurate to the order of a few centimeters or less) position and orientation. The AV 1002 can focus its search based on sensor data from one or more first sensor systems (e.g., GPS) by matching sensor data from one or more second sensor systems (e.g., LIDAR). If the mapping and localization information from one system is unavailable, the AV 1002 can use mapping and localization information from a redundant system and/or from remote data sources.

The planning stack 1016 can determine how to maneuver or operate the AV 1002 safely and efficiently in its environment. For example, the planning stack 1016 can receive the location, speed, and direction of the AV 1002, geospatial data, data regarding objects sharing the road with the AV 1002 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 1002 from one point to another. The planning stack 1016 can determine multiple sets of one or more mechanical operations that the AV 1002 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 1016 can select from multiple backup plans to carry out. For example, while preparing to change lanes to turn right at an intersection, another vehicle may aggressively cut into the destination lane, making the lane change unsafe. The planning stack 1016 could have already determined an alternative plan for such an event, and upon its occurrence, help to direct the AV 1002 to go around the block instead of blocking a current lane while waiting for an opening to change lanes.

The control stack 1018 can manage the operation of the vehicle propulsion system 1030, the braking system 1032, the steering system 1034, the safety system 1036, and the cabin system 1038. The control stack 1018 can receive sensor signals from the sensor systems 1004-1008 as well as communicate with other stacks or components of the local computing device 1010 or a remote system (e.g., the data center 1050) to effectuate operation of the AV 1002. For example, the control stack 1018 can implement the final path or actions from the multiple paths or actions provided by the planning stack 1016. This can involve turning the routes and decisions from the planning stack 1016 into commands for the actuators that control the AV's steering, throttle, brake, and drive unit.

The communication stack 1020 can transmit and receive signals between the various stacks and other components of the AV 1002 and between the AV 1002, the data center 1050, the client computing device 1070, and other remote systems. The communication stack 1020 can enable the local computing device 1010 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 1020 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 1022 can store HD maps and related data of the streets upon which the AV 1002 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 1024 can store raw AV data generated by the sensor systems 1004-1008 and other components of the AV 1002 and/or data received by the AV 1002 from remote systems (e.g., the data center 1050, the client computing device 1070, etc.). In some embodiments, the raw AV data can include HD LIDAR point cloud data, image or video data, RADAR data, GPS data, and other sensor data that the data center 1050 can use for creating or updating AV geospatial data as discussed further below with respect to FIG. 5 and elsewhere in the present disclosure.

The data center 1050 can be a private cloud (e.g., an enterprise network, a co-location provider network, etc.), a public cloud (e.g., an Infrastructure as a Service (IaaS) network, a Platform as a Service (PaaS) network, a Software as a Service (Saas) network, or other Cloud Service Provider (CSP) network), a hybrid cloud, a multi-cloud, and so forth. The data center 1050 can include one or more computing devices remote to the local computing device 1010 for managing a fleet of AVs and AV-related services. For example, in addition to managing the AV 1002, the data center 1050 may also support a ridesharing service, a delivery service, a remote/roadside assistance service, street services (e.g., street mapping, street patrol, street cleaning, street metering, parking reservation, etc.), and the like.

The data center 1050 can send and receive various signals to and from the AV 1002 and the client computing device 1070. These signals can include sensor data captured by the sensor systems 1004-1008, roadside assistance requests, software updates, ridesharing pick-up and drop-off instructions, and so forth. In this example, the data center 1050 includes one or more of a data management platform 1052, an Artificial Intelligence/Machine Learning (AI/ML) platform 1054, a simulation platform 1056, a remote assistance platform 1058, a ridesharing platform 1060, and a map management platform 1062, among other systems.

Data management platform 1052 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 1050 can access data stored by the data management platform 1052 to provide their respective services.

The AI/ML platform 1054 can provide the infrastructure for training and evaluating machine learning algorithms for operating the AV 1002, the simulation platform 1056, the remote assistance platform 1058, the ridesharing platform 1060, the map management platform 1062, and other platforms and systems. Using the AI/ML platform 1054, data scientists can prepare data sets from the data management platform 1052; select, design, and train machine learning models; evaluate, refine, and deploy the models; maintain, monitor, and retrain the models; and so on.

The simulation platform 1056 can enable testing and validation of the algorithms, machine learning models, neural networks, and other development efforts for the AV 1002, the remote assistance platform 1058, the ridesharing platform 1060, the map management platform 1062, and other platforms and systems. The simulation platform 1056 can replicate a variety of driving environments and/or reproduce real-world scenarios from data captured by the AV 1002, including rendering geospatial information and road infrastructure (e.g., streets, lanes, crosswalks, traffic lights, stop signs, etc.) obtained from the map management platform 1062; modeling the behavior of other vehicles, bicycles, pedestrians, and other dynamic elements; simulating inclement weather conditions, different traffic scenarios; and so on.

The remote assistance platform 1058 can generate and transmit instructions regarding the operation of the AV 1002. For example, in response to an output of the AI/ML platform 1054 or other system of the data center 1050, the remote assistance platform 1058 can prepare instructions for one or more stacks or other components of the AV 1002.

The ridesharing platform 1060 can interact with a customer of a ridesharing service via a ridesharing application 1072 executing on the client computing device 1070. The client computing device 1070 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 1072. The client computing device 1070 can be a customer's mobile computing device or a computing device integrated with the AV 1002 (e.g., the local computing device 1010). The ridesharing platform 1060 can receive requests to be picked up or dropped off from the ridesharing application 1072 and dispatch the AV 1002 for the trip.

Map management platform 1062 can provide a set of tools for the manipulation and management of geographic and spatial (geospatial) and related attribute data. The data management platform 1052 can receive LIDAR point cloud data, image data (e.g., still image, video, etc.), RADAR data, GPS data, and other sensor data (e.g., raw data) from one or more AVs 1002, Unmanned Aerial Vehicles (UAVs), satellites, third-party mapping services, and other sources of geospatially referenced data. The raw data can be processed, and map management platform 1062 can render base representations (e.g., tiles (2D), bounding volumes (3D), etc.) of the AV geospatial data to enable users to view, query, label, edit, and otherwise interact with the data. Map management platform 1062 can manage workflows and tasks for operating on the AV geospatial data. Map management platform 1062 can control access to the AV geospatial data, including granting or limiting access to the AV geospatial data based on user-based, role-based, group-based, task-based, and other attribute-based access control mechanisms. Map management platform 1062 can provide version control for the AV geospatial data, such as to track specific changes that (human or machine) map editors have made to the data and to revert changes when necessary. Map management platform 1062 can administer release management of the AV geospatial data, including distributing suitable iterations of the data to different users, computing devices, AVs, and other consumers of HD maps. Map management platform 1062 can provide analytics regarding the AV geospatial data and related data, such as to generate insights relating to the throughput and quality of mapping tasks.

In some embodiments, the map viewing services of map management platform 1062 can be modularized and deployed as part of one or more of the platforms and systems of the data center 1050. For example, the AI/ML platform 1054 may incorporate the map viewing services for visualizing the effectiveness of various object detection or object classification models, the simulation platform 1056 may incorporate the map viewing services for recreating and visualizing certain driving scenarios, the remote assistance platform 1058 may incorporate the map viewing services for replaying traffic incidents to facilitate and coordinate aid, the ridesharing platform 1060 may incorporate the map viewing services into the client application 1072 to enable passengers to view the AV 1002 in transit en route to a pick-up or drop-off location, and so on.

### Example Processing System

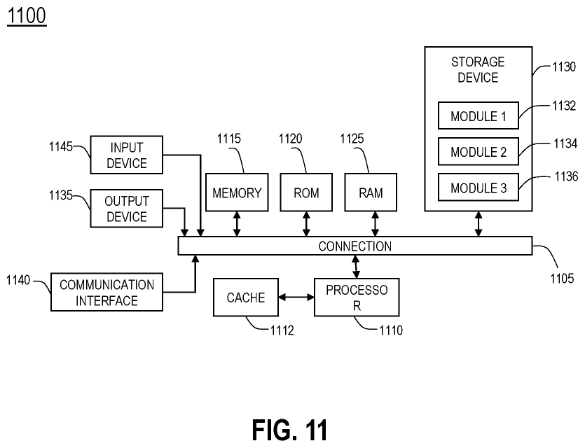

FIG. 11 illustrates an example processor-based system with which some aspects of the subject technology can be implemented. For example, processor-based system 1100 can be any computing device making up, or any component thereof in which the components of the system are in communication with each other using connection 1105. In some examples, the processor-based system 1100 is in an autonomous vehicle. In some examples, the processor-based system, 1100 is in a robot and/or in a robotic arm. In some examples, the processor-based system is in a charging station, and/or the processor-based system is in a charging facility. Connection 1105 can be a physical connection via a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (Central Processing Unit (CPU) or processor) 1110 and connection 1105 that couples various system components including system memory 1115, such as Read-Only Memory (ROM) 1120 and Random-Access Memory (RAM) 1125 to processor 1110. Computing system 1100 can include a cache of high-speed memory 1112 connected directly with, in close proximity to, or integrated as part of processor 1110.

Processor 1110 can include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms known to those of skill in the art. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 1130 can include software services, servers, services, etc., that when the code that defines such software is executed by the processor 1110, it causes the system 1100 to perform a function. In some embodiments, a hardware service that performs a particular function can include the software component stored in a computer-readable medium in connection with the necessary hardware components, such as processor 1110, connection 1105, output device 1135, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Example 1 provides a method for vehicle charging, comprising: receiving a message indicating that a vehicle is arriving at a charging facility at a first time; identifying a parking spot for the vehicle based on a current location of a robotic arm, wherein the parking spot has a corresponding charging station; determining a second time at which the robotic arm is scheduled to be at the parking spot, wherein the second time is based on the first time; moving the robotic arm to the parking spot, wherein the robotic arm arrives at the parking spot by approximately the second time; and using the robotic arm, automatically connecting a charging station plug with a charging port on the vehicle.

Example 2 provides a method, system, and/or vehicle according to one or more of the preceding and/or following examples, further comprising receiving status information from the vehicle, wherein the status information includes a current state of charge of the vehicle.

Example 3 provides a method, system, and/or vehicle according to one or more of the preceding and/or following examples, wherein the parking spot is a first parking spot, and further comprising: receiving a first flag for the first parking spot, wherein the first flag indicates a first service request for the robotic arm; and receiving a second flag for a second parking spot, wherein the second flag indicates a second service request for the robotic arm.

Example 4 provides a method, system, and/or vehicle according to one or more of the preceding and/or following examples, further comprising: determining that the second parking spot is between the current robotic arm location and the first parking spot; and stopping the robotic arm at the second parking spot to attend to the second service request before stopping the robotic arm at the first parking spot to attend to the first service request.

Example 5 provides a method, system, and/or vehicle according to one or more of the preceding and/or following examples, wherein the vehicle is a first vehicle, and further comprising: receiving first status information from the first vehicle; and receiving second status information from a second vehicle, wherein the second vehicle is assigned to the second parking spot.

Example 6 provides a method, system, and/or vehicle according to one or more of the preceding and/or following examples, further comprising determining a first stop for the robotic arm based on the first and second status information, wherein the first stop is one of the first parking spot and the second parking spot.

Example 7 provides a method, system, and/or vehicle according to one or more of the preceding and/or following examples, wherein moving the robotic arm comprises moving the robotic arm along a track in an overhead gantry system.

Example 8 provides a method, system, and/or vehicle according to one or more of the preceding and/or following examples, wherein moving the robotic arm comprises autonomously moving a wheeled base vehicle attached to the robotic arm.

Example 9 provides a system for automated fleet charging, comprising a plurality of parking spots; a plurality of charging stations, each respective charging station corresponding to a respective parking spot, wherein each charging station has a charging plug; a gantry track spanning the plurality of parking spots and positioned in close proximity to each of the charging stations; a robotic arm configured to travel along the gantry track, wherein the robotic arm is configured to move the charging plug at respective ones of plurality of charging stations.

Example 10 provides a method, system, and/or vehicle according to one or more of the preceding and/or following examples, wherein the robotic arm is further configured to open a charging port on a vehicle.

Example 11 provides a method, system, and/or vehicle according to one or more of the preceding and/or following examples, wherein the robotic arm includes a head portion with a clasping mechanism.

Example 12 provides a method, system, and/or vehicle according to one or more of the preceding and/or following examples, wherein the clasping mechanism is one of a pincher and a robotic hand.

Example 13 provides a method, system, and/or vehicle according to one or more of the preceding and/or following examples, wherein the clasping mechanism is configured to clasp the charging plug, and the robotic arm is configured to connect the charging plug with a charging port on a vehicle and to disconnect the charging plug from a charging port on a vehicle.

Example 14 provides a method, system, and/or vehicle according to one or more of the preceding and/or following examples, wherein the gantry track is an overhead gantry track positioned above the plurality of parking spots such that the robotic arm can traverse the plurality of parking spots traveling along the gantry track.

Example 15 provides a method, system, and/or vehicle according to one or more of the preceding and/or following examples, wherein the robotic arm is further configured to: receive a first flag for a first parking spot, wherein the first flag indicates a first service request; receive a second flag for a second parking spot, wherein the second flag indicates a second service request; determine whether the second parking spot is between a current robotic arm location and the first parking spot; and when the second parking spot is between the current robotic arm location and the first parking spot, stop at the second parking spot to attend to the second service request before stopping at the first parking spot to attend to the first service request.

Example 16 provides a system for automated fleet charging, comprising a plurality of fleet vehicles, a dispatch service in communication with each of the plurality of fleet vehicles, wherein the dispatch service is configured to transmit a message indicating that a first vehicle from the plurality of fleet vehicles is arriving at a charging facility at a first time, the charging facility, including: a plurality of parking spots; a plurality of charging stations, each respective charging station corresponding to a respective parking spot, wherein each charging station has a charging plug; a gantry track spanning the plurality of parking spots and positioned in close proximity to each of the charging stations; a robotic arm configured to travel along the gantry track, wherein the robotic arm is configured to move the charging plug at respective ones of plurality of charging stations.

Example 17 provides a method, system, and/or vehicle according to one or more of the preceding and/or following examples, the charging facility is configured to: identify a first parking spot from the plurality of parking spots for the first vehicle based on a current location of the robotic arm; and determine a second time at which the robotic arm is scheduled to be at the first parking spot, wherein the second time is based on the first time; communicate a message to the robotic arm including the second time and the first parking spot.

Example 18 provides a method, system, and/or vehicle according to one or more of the preceding and/or following examples, wherein the robotic arm is configured to move along the gantry track to the first parking spot and arrive at the first parking spot at approximately the second time, and connect the charging plug with a charging port on the first vehicle.

Example 19 provides a method, system, and/or vehicle according to one or more of the preceding and/or following examples, wherein the robotic arm is further configured to receive a first flag for the first parking spot, wherein the first flag indicates a first service request for the robotic arm; and receive a second flag for a second parking spot, wherein the second flag indicates a second service request for the robotic arm.

Example 20 provides a method, system, and/or vehicle according to one or more of the preceding and/or following examples, wherein the robotic arm is further configured to: determine whether the second parking spot is between a current robotic arm location and the first parking spot; and when the second parking spot is between the current robotic arm location and the first parking spot, stop at the second parking spot to attend to the second service request before stopping at the first parking spot to attend to the first service request.

Example 21 provides a method for automated fleet-connected charging, comprising receiving a first flag indicating a first request for attention at a first parking spot, wherein the first parking spot has a first charging station; scheduling the first parking spot as the next destination for a robotic arm; receiving a second flag indicating a second request for attention at a second parking spot, wherein the second parking spot has a second charging station; determine whether the second parking spot is between a current robotic arm location and the first parking spot; when the second parking spot is between the current robotic arm location and the first parking spot, stopping the robotic arm at the second parking spot before proceeding to the first parking spot; and when the second parking spot is not between the current robotic arm location and the first parking spot, stopping the robotic arm at the first parking spot before proceeding to the second parking spot.

Example 22 provides a method, system, and/or vehicle according to one or more of the preceding and/or following examples, wherein at least one of the first and second requests for attention includes a request to connect the respective first and second vehicles with respective charging plugs from the first and second charging stations.

Example 23 provides a method, system, and/or vehicle according to one or more of the preceding and/or following examples, wherein a charging spot is a parking spot having a corresponding charging station.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A method for vehicle charging, comprising:
receiving a message indicating that a vehicle is arriving at a charging facility at a first time;
identifying a charging spot for the vehicle based on a current location of a robotic arm, wherein the charging spot has a corresponding charging station;
determining a second time at which the robotic arm is scheduled to be at the charging spot, wherein the second time is based on the first time;
moving the robotic arm to the charging spot, wherein the robotic arm arrives at the charging spot by approximately the second time; and
using the robotic arm, automatically connecting a charging station plug with a charging port on the vehicle.

2. The method of claim 1, further comprising receiving status information from the vehicle, wherein the status information includes a current state of charge of the vehicle.

3. The method of claim 1, wherein the charging spot is a first charging spot, and further comprising:
receiving a first flag for the first charging spot, wherein the first flag indicates a first service request for the robotic arm; and
receiving a second flag for a second charging spot, wherein the second flag indicates a second service request for the robotic arm.

4. The method of claim 3, further comprising:
determining that the second charging spot is between the current robotic arm location and the first charging spot; and
stopping the robotic arm at the second charging spot to attend to the second service request before stopping the robotic arm at the first charging spot to attend to the first service request.

5. The method of claim 3, wherein the vehicle is a first vehicle, and further comprising:
receiving first status information from the first vehicle; and
receiving second status information from a second vehicle, wherein the second vehicle is assigned to the second charging spot.

6. The method of claim 5, further comprising determining a first stop for the robotic arm based on the first and second status information, wherein the first stop is one of the first charging spot and the second charging spot.

7. The method of claim 1, wherein moving the robotic arm comprises moving the robotic arm along a track in an overhead gantry system.

8. The method of claim 1, wherein moving the robotic arm comprises autonomously moving a wheeled base vehicle attached to the robotic arm.

9. A system for automated fleet charging, comprising:
a plurality of charging spots;
a plurality of charging stations, each respective charging station corresponding to a respective charging spot, wherein each charging station has a charging plug;
a gantry track spanning the plurality of charging spots and positioned in close proximity to each of the charging stations;
a robotic arm configured to travel along the gantry track, wherein the robotic arm is configured to move the charging plug at respective ones of plurality of charging stations.

10. The system of claim 9, wherein the robotic arm is further configured to open a charging port on a vehicle.

11. The system of claim 9, wherein the robotic arm includes a head portion with a clasping mechanism.

12. The system of claim 11, wherein the clasping mechanism is one of a pincher and a robotic hand.

13. The system of claim 11, wherein the clasping mechanism is configured to clasp the charging plug, and the robotic arm is configured to connect the charging plug with a charging port on a vehicle and to disconnect the charging plug from a charging port on a vehicle.

14. The system of claim 9, wherein the gantry track is an overhead gantry track positioned above the plurality of charging spots such that the robotic arm can traverse the plurality of charging spots traveling along the gantry track.

15. The system of claim 9, wherein the robotic arm is further configured to:
receive a first flag for a first charging spot, wherein the first flag indicates a first service request;
receive a second flag for a second charging spot, wherein the second flag indicates a second service request;
determine whether the second charging spot is between a current robotic arm location and the first charging spot; and
when the second charging spot is between the current robotic arm location and the first charging spot, stop at the second charging spot to attend to the second service request before stopping at the first charging spot to attend to the first service request.

16. A system for automated fleet charging, comprising:
a plurality of fleet vehicles
a dispatch service in communication with each of the plurality of fleet vehicles, wherein the dispatch service is configured to transmit a message indicating that a first vehicle from the plurality of fleet vehicles is arriving at a charging facility at a first time;
the charging facility, including:
a plurality of charging spots;
a plurality of charging stations, each respective charging station corresponding to a respective charging spot, wherein each charging station has a charging plug;
a gantry track spanning the plurality of charging spots and positioned in close proximity to each of the charging stations;
a robotic arm configured to travel along the gantry track, wherein the robotic arm is configured to move the charging plug at respective ones of plurality of charging stations.

17. The system of claim 16, wherein the charging facility is configured to:
identify a first charging spot from the plurality of charging spots for the first vehicle based on a current location of the robotic arm; and
determine a second time at which the robotic arm is scheduled to be at the first charging spot, wherein the second time is based on the first time;
communicate a message to the robotic arm including the second time and the first charging spot.

18. The system of claim 17, wherein the robotic arm is configured to:
move along the gantry track to the first charging spot and arrive at the first charging spot at approximately the second time, and
connect the charging plug with a charging port on the first vehicle.

19. The system of claim 17, wherein the robotic arm is further configured to:
receive a first flag for the first charging spot, wherein the first flag indicates a first service request for the robotic arm; and
receive a second flag for a second charging spot, wherein the second flag indicates a second service request for the robotic arm.

20. The system of claim 19, wherein the robotic arm is further configured to:
determine whether the second charging spot is between a current robotic arm location and the first charging spot; and
when the second charging spot is between the current robotic arm location and the first charging spot, stop at the second charging spot to attend to the second service request before stopping at the first charging spot to attend to the first service request.
